(19) United States
(12) Patent Application Publication
(10) Pub. No.: US 2009/0259721 A1
(43) Pub. Date: Oct. 15, 2009

(54) IMS quietude manager

(75) Inventors: Arnaud Gonguet, Paris (FR); Yann Gaste, Le Plessis-Robinson (FR)

Correspondence Address: ALCATEL-LUCENT, C/O GALASSO & ASSOCIATES, LP, P. O. BOX 26503, AUSTIN, TX, 78755-0503, US

(73) Assignee: ALCATEL LUCENT

(21) Appl. No.: 12/082,116

(22) Filed: Apr. 9, 2008

(51) Int. Cl. G06F 15/16

(52) U.S. Cl. 709/206; 709/217

(57) ABSTRACT

IMS Quietude Manager is a method and device for unifying reaction to an undesired contact regardless of communication means. In the preferred embodiment, the methodology involves utilizing a quietude key integrated in the IMS client that activates a quietude manager of an IMS. The quietude manager is capable of accessing the reachability server, the Group List Management Server (GLMS) and the presence server of the IMS to provide an appropriate response to any given communication.

### CROSS REFERENCE TO RELATED APPLICATIONS

This United States Non-Provisional Patent Application does not claim priority to any United States Provisional Patent Application or any foreign patent application.

### FIELD OF THE DISCLOSURE

The disclosures made herein relate generally to the global communication industry. The invention discussed herein is in the general classification of IP Multimedia Subsystem (IMS) services.

### BACKGROUND

IMS is a technology that has been developed by cellular phone-carriers. It has been standardized, adopted and endorsed by groups of telecommunications associations in order to make a globally applicable mobile phone system.

The IMS introduces global communication, with a single SIP address and a single communication client, giving access to all communication services (e.g. voice-over-IP (VoIP), instant messaging (IM), push to talk, multimedia messaging services (MMS), etc.). The Session Initiation Protocol (SIP) is an application-layer control (signaling) protocol for creating, modifying, and terminating sessions with one or more participants.

IMS application server and enablers allow mobile service providers to quickly introduce and deliver innovative applications to end users, helping mobile service providers generate significant operational savings.

IMS solutions enable the delivery of advanced EP multimedia services, such as VoIP, push-to-talk, multimedia conferencing, presence-based communication, and other interactive applications with a guaranteed quality of service. These solutions also enable the control of media-rich SIP sessions between terminals and devices over any fixed or mobile access network, including second-generation and third-generation wireless, digital subscriber line (xDSL), and wireless access such as Local Area Network (LAN) WiFi hotspots and WiMAX.

Unfortunately, this multitude of services also creates many ways to be canvassed, flooded and disturbed with communications. A SIP address may spread and be used by unknown contacts such as advertisers. Even known and granted contacts may be disturbing in certain circumstances (e.g. the daily call of the boring aunt or the chat-speaking nephew on IM).

Currently, several different solutions exist to react to undesired contacting depending on the medium. For instance, anti-spam tools are used to detect and eliminate unwanted e-mails. Voice mail redirection buttons are used to eliminate and effectively manage undesirable voice calls. IM contacts may be suppressed.

These solutions are specific to a communication medium. They come with their own configuration means and do not cooperate with one another (e.g. blacklisting an email contact has no influence on VoIP or other services).

Another problem is that these reactions are not discriminative with respect to the target. Blacklisting an unknown contact has the same effect as blacklisting a relative. The reaction is not adapted and there is no gradation of the retaliation for an unwanted communication. Blacklisting is the only final solution.

These solutions also provide no adaptation with respect to the context. An IMS client may have a different reaction to a phone call depending on whether he or she is at work, home or dining in a restaurant.

Hence, there is a need in the art for a convenient to use, reliable, and inexpensive method/device for unifying reaction to an undesired contact regardless of communication means that is adapted to the circumstance.

### SUMMARY OF THE DISCLOSURE

The IMS Quietude Manager is a method and device for unifying reaction to an undesired contact regardless of communication means.

The principal object of this invention is to provide a method and device for unifying reaction to an undesired contact regardless of communication means.

Another object of this invention is to provide a method and device for unifying reaction to an undesired contact adapted to the circumstance.

Another object of this invention is to provide a method and device that utilizes a quietude key on the IMS client for unifying reaction to an undesired contact regardless of communication means.

Another object of this invention is to provide a method and device for unifying reaction to an undesired contact regardless of communication means that is relatively inexpensive to implement, maintain or manufacture.

Another object of this invention is to provide a method and device for unifying reaction to an undesired contact that relies on both presence information and a contact book to evaluate the displeasure of the user (e.g. different levels of quietude at home when a friend calls versus at work when an unknown contact calls).

Another object of this invention is to provide a method and device for unifying reaction to an undesired contact that permits updating of reachability status for individuals and groups permitting temporary and permanent blacklisting.

Another object of this invention is to provide a reliable method and device for unifying reaction to an undesired contact.

Yet another object of this invention is to provide a convenient to use method and device for unifying reaction to an undesired contact regardless of communication means.

### BRIEF DESCRIPTION OF THE DRAWINGS

FIG. 1 depicts a diagram showing an implementation of the preferred method on the present invention with an IMS client in an IMS receiving a communication from a party/device.

FIG. 2 depicts a diagram of the component blocks of the quietude manager of the IMS in the preferred embodiment.

### DETAILED DESCRIPTION OF THE DRAWINGS

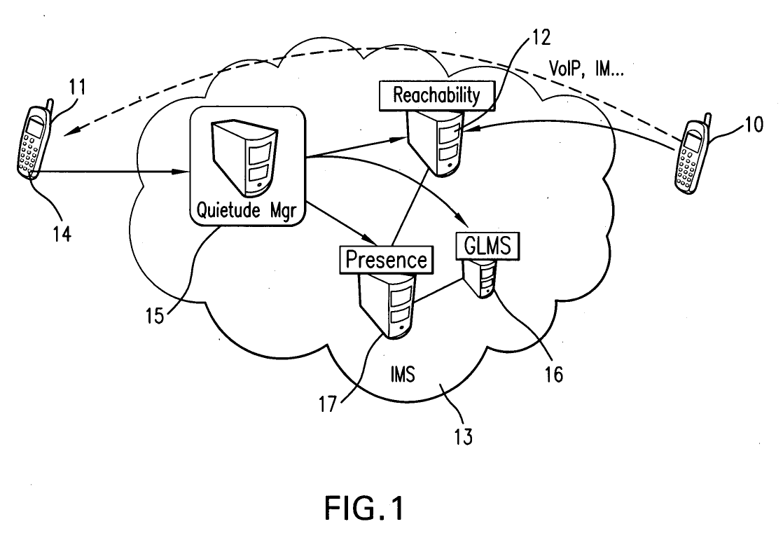

FIG. 1 depicts a diagram showing an implementation of the preferred method with an IMS client in an IMS receiving a communication from a party/device. The preferred embodiment of the method involves a dual client/server solution deployed in the IMS platform.

When a party 10 attempts to reach an IMS client 11, the party 10 first accesses the reachability server 12 of the IMS 13. The reachability server 12 is connected to the presence server 17 and contains the presence status of the IMS client 11. Depending on the response from the reachability server 12, the party 10 may then initiate a communication with the IMS client 11. The party 10 may be a known or unknown contact of the IMS client 11.

In the preferred embodiment, the client part of the methodology involves utilizing a one-click quietude key 14 integrated in the IMS client 11 to activate or deactivate the quitetude manager 15 of the IMS 13. The quietude key 14 can then be activated automatically in correlation with a communication event (e.g. VoIP call or IM) that is analyzed to retrieve the identifier of the party 10 (e.g. in the INVITE message for a VoIP call for instance).

An IMS client 11 may want some quietude for many different reasons. If an IMS client is dining, attending a meeting, or simply does not want to talk to certain parties on any given day, he or she may want to utilize the quitetude key 14.

The objective of the quietude manager 15 is to provide a reaction adapted to the reason a client requested quietude. The quietude manager 15 is triggered with the identifier of the party 10. The quietude manager 15 is capable of accessing the reachability server 12, the Group List Management Server (GLMS) 16 and the presence server 17.

In the preferred embodiment, the reachability server 12 contains information on whether certain parties may contact a client at a given time. The GLMS 16 contains a grouping of parties (e.g. family or friends). The presence server 17 contains information on the whereabouts of the client (e.g. home or work).

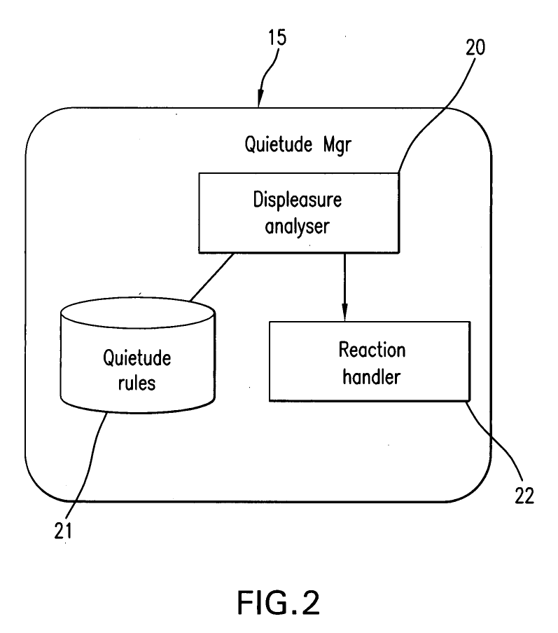

FIG. 2 depicts a diagram of the component blocks of the quietude manager of the IMS in the preferred embodiment. The quietude manager 15 is composed of the following blocks: the displeasure analyzer 20, quietude rules database 21, and reaction handler 22.

The displeasure analyzer 20 retrieves the group of the party in the GLMS and the IP client's current presence status in the presence server. It correlates that information to evaluate the IMS client's displeasure, in order to have an adapted reaction, pursuant to the quietude rules database 21.

The quietude rules database 21 is a user configurable repository of rules that aims at discriminating between different situations. For example, if the party initiating the communication is a family member and the IMS client's presence is set to “dining,” the reaction may be set to redirect the call to voice mail. If, however, the party is unknown and the IMS client is at home, the reaction may be set to blacklist the party. If the party is a friend or relative and the IMS client is in a business meeting, the IMS client's reachability could be temporarily turned to offline. This allows for a graduated and measured response to specific situations and individuals rather than blacklisting a friend, relative or unknown contact irrespective of the situation.

The reaction handler 22 enforces the selected reaction in three different ways. First, the communication is either redirected to the voice mail box or simply disconnected, depending on the situation. Second, the reachability status may be updated in the reachability server in order to temporarily or permanently restrict the possibility of a given party reaching the IP client. Third, the party's group status may be updated in the GLMS in order to apply more restrictive reachability policies in the future.

It is contemplated that the method described herein can be implemented as software, including a computer-readable medium having program instructions executing on a computer, hardware, firmware, or a combination thereof. The method described herein also may be implemented in various combinations on hardware and/or software.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A method of reaction to a party electronic communication to an IMS client comprising the steps of:
(a) accessing a reachability server in an IMS in response to a communication from a party directed to an IMS client;
(b) activating a quietude key integrated in the IMS client; and
(c) activating a quietude manager capable of accessing the reachability server, a group list management server and a presence server.

2. The method of claim 1 wherein the communication is a text message.

3. The method of claim 1 wherein the communication is a voice call.

4. The method of claim 1 wherein the communication is an electronic mail.

5. The method of claim 1 wherein the reachability server contains a presence status of the IMS client.

6. The method of claim 1 wherein the step of activating the quitetude key involves manually pressing the quietude key.

7. The method of claim 1 wherein the step of activating the quietude key is done automatically in response to a communication.

8. The method of claim 1 wherein the quietude manager has a displeasure analyzer, a quietude rules database, and a reaction handler.

9. The method of claim 8 further comprising the step of:
using the displeasure analyzer to retrieve a group status of the party in the group list management server and a presence status of the IMS client in the presence server.

10. The method of claim 9 further comprising the step of:
using the displeasure analyzer to correlate the group status and the presence status to evaluate a reaction of the IMS client based on the quietude rules database.

11. The method of claim 8 wherein the quietude rules database is a user configurable repository of rules.

12. The method of claim 10 further comprising the step of:
using the reaction handler to redirect the communication to a voice mail box of the IMS client.

13. The method of claim 10 further comprising the step of:
using the reaction handler to terminate the communication with the party.

14. The method of claim 10 further comprising the step of:
using the reaction handler to update a reachability status for the party in the reachability server.

15. The method of claim 9 further comprising the step of:
using the reaction handler to update the group status in the group list management server.

16. A device for unifying reaction to an electronic communication destined for an IMS client from a party comprising:
(a) a displeasure analyzer;
(b) a quietude rules database connected to the displeasure analyzer; and
(c) a reaction handler responsive to the displeasure analyzer.

17. The device of claim 16 further comprising:
a presence server and a group list management server operatively connected to the displeasure analyzer.

18. The device of claim 17 further comprising:
a reachability server operatively connected to the reaction handler.

19. The device of claim 18 further comprising:
a quietude key located on an IMS client operatively connected to the displeasure analyzer.

20. A method of reaction to a party electronic communication to an IMS client comprising the steps of:
(a) activating a quietude key integrated in the IMS client; and
(c) activating a quietude manager capable of accessing a reachability server, a group list management server and a presence server.
